(19) United States
(12) Patent Application Publication
(10) Pub. No.: US 2024/0319024 A1
(43) Pub. Date: Sep. 26, 2024

(54) Self-Powered Smart Skins for Multimodal Static and Dynamic Tactile Perception

(71) Applicant: The University of Hong Kong, Hong Kong (CN)

(72) Inventors: Dongmyeong SHIN, West Kowloon (CN); Xiaoting MA, Hong Kong (CN); Eunjong KIM, Hong Kong (CN); Jiaming Zhou, Hong Kong (CN); Jingyi GAO, Hong Kong (CN)

(73) Assignee: The University of Hong Kong, Hong Kong (CN)

(21) Appl. No.: 18/596,220

(22) Filed: Mar. 5, 2024

Related U.S. Application Data
(60) Provisional application No. 63/453,817, filed on Mar. 22, 2023.

(51) Int. Cl. G01L 1/00; G01H 1/00; G01N 27/04

(52) U.S. Cl. CPC G01L 1/005; G01H 1/00; G01N 27/048

(57) ABSTRACT

A smart skin system includes tactile sensors that mimic the functions of human skin by sensing pressure, vibration and humidity simultaneously and generate electric signals as a result thereof; and a machine learning assisted data processor that interprets the electric signals from the sensors and quantitively perceives the stimulation in terms of pressure, vibration, and environmental humidity. The sensor structurally comprises (1) a single-ion conducting electrolyte, which provides contact electrification, serves as a hygroscopic layer and produces DC hygroelectric signals in response to humidity, (2) a gold electrode and (3) a separatable aluminum electrode as a counter triboelectrification layer that produces AC triboelectric signals in response to contact.

### CROSS-REFERENCE TO RELATED PATENT APPLICATIONS

This application claims the benefit of priority under 35 U.S.C. Section 119(e) of U.S. Application No. 63/453,817 filed Mar. 22, 2023, which is incorporated herein by reference in its entirety.

### FIELD OF THE INVENTION

The present invention relates to a smart skin system including tactile sensors and machine learning assisted data procession technology.

### BACKGROUND OF THE INVENTION

Human skin plays an essential role in tactile sensation when in direct contact with the external environment as an integumentary layer of the body. Tactile modalities, such as pressure, vibration, warm, cold, and wetness, activate the subcutaneous sensory receptors, offering electrical signals for further identification and interpretation of the stimuli information at the somatosensory cortex [1]. The mechanoreceptors perceive pressure and vibration, while thermoreceptors encode thermal stimuli. In particular, the humidity can be detected by thermoreceptors in tandem with the mechanoreceptors in the human skin due to the absence of hygroreceptors [2]. Increasing demand in various industrial sectors, including robotics [3-5], prosthetics [6], and healthcare [7, 8] is triggering research into tactile sensors that feature sensitivity to pressure [9, 10], temperature [111], and humidity. [12] Some efforts have been successful in making devices that mimic the static tactile sensation based on the various piezoresistive [13, 14], piezoelectric [15, 16], capacitive [13, 17], and pyroelectric [18, 19] working principles. However, the slow response rate of functional materials has hindered fast response to dynamic stimuli [20, 21]. Further, as perception includes the processes of not only tactile sensing on the skin, but also identification and interpretation in the brain, it remains challenging to exactly imitate the tactile perception of the human body. Although consciously coded analytic software has proven capable of performing well for identification and interpretation, it still requires sophisticated data acquisition and processing algorithms. Hence, there is a need for a smart tactile perception system in the range of detection to interpretation, including but not limited to organization, identification, and prediction in a manner that is low-cost and highly efficient.

Triboelectric nanogenerators (TENGs) have been successfully proposed for encryption technology of mechanical to electrical domains in the broad range of stimuli frequency, being demonstrated as energy harvesters [22-28] and sensors [29-32]. The TENGs can be served as a powerful tool to effectively sense the dynamic tactile sensation since they provide many advantages, such as simple fabrication, simple device structure, lightweight, fast response time and high energy conversion efficiency. [33, 34] On the other hand, the working mechanism of contact electrification and electrostatic induction inherently limits the sensitivity of TENGs to static tactile sensation.

Lots of smart skin systems have been developed. However, due to the lack of versatile sensors and the limitation of data processing technology, most of the existing smart skin systems are only able to detect one or two types of stimuli. Systems with more functions require complicated integration of elements or devices. For example, China Patent CN2021-10595535.8A discloses an array type flexible electronic skin for robot tactile feedback. The electronic skin unit comprises a substrate, an electrochromic pressure display unit located on the substrate and a triboelectric pressure sensitive unit located on the electrochromic pressure display unit. This type of electronic skin can only sense the static pressure and dynamic touch by stacking electrochromic pressure displays and triboelectric units. Further, it requires an external power supply.

Also, a paper entitled “Piezoionic mechanoreceptors: Force-induced current generation in hydrogels,” https://www.science.org/doi/10.1126/science.aaw1974 suggests the use of salt doped hydrogel to sense dynamic force. This structure cannot sense static pressure because it relies on the different mobility of anions and cations during the deforming process of the hydrogel. Furthermore, the output signal is small, just tens of millivolts.

### SUMMARY OF THE INVENTION

According to the present invention a smart skin system includes tactile sensors and machine learning assisted data processing technology. The sensor mimics the functions of human skin in that it has the ability to sense pressure, vibration and humidity simultaneously and generates electric signals as a result. A machine learning assisted data processor interprets the electric signals from the sensors and quantitively perceives the stimulation in terms of pressure, vibration, and environmental humidity. The sensor is structurally composed of three layers: (1) a single-ion conducting electrolyte, which provides contact electrification and serves as a hygroscopic layer, (2) a gold electrode and (3) a separable aluminium electrode that serves as a counter triboelectrification layer and electrode. The hygroscopic layer generates DC hygroelectric (HE) signals in response to humidity and the triboelectrification layer generates AC triboelectric signals (TE) in response to physical contact, e.g., repeated pressure and release.

The triboelectric and hygroelectric signals from the sensor are recorded and are transmitted to a main server computer for interpretation with the help of machine learning, so as to imitate the peripheral and central nervous systems of humans. This smart skin system is multifunctional, self-powered, simply structured, low cost and high efficiency.

The high-performing smart skins of the present invention mimic multimodal tactile perception based on triboelectricity principles, which relate to a type of contact electrification by which certain materials become electrically charged after they are separated from a different material with which they were in contact, in tandem with hygroelectricity, which is a type of static electricity that forms on water droplets and can be transferred from droplets to small dust particles. The key features mimicked for tactile perception are both static and dynamic responses of the sensing module, signal transmission, and data processing in the range of stimuli to perception. By the integration of a hygroscopic contact electrification layer into triboelectric nanogenerators (TENGs) the triboelectric smart skins module is made sensitive to static stimuli in addition to the dynamic stimuli. Besides, the functional hygroscopic contact electrification layer provides moisture sensitivity to smart skin modules for wetness sensing.

The encoded signal measured by the smart skins module is wirelessly transmitted to a central computer, and interpreted in the central computer with supervised machine learning. The smart skin system is shown to transcend the human sensory system in terms of quantitative pressure, vibration, and humidity perception, providing a new paradigm for a self-powered multimodal smart skin featuring low cost and high efficiency. It thus has potential for applications in fields such as robotics, prosthetics, healthcare and human machine interfaces.

In this invention, when applying a periodic force of compression and release, the smart skin yields the instantaneous voltage outputs arising from the contact electrification between the electrolyte and the Al electrode, allowing it to mimic the fast adapting mechanoreceptors of human skin; while the slow adapting mechanoreceptors are emulated by the steady voltage outputs generated by ion diffusion throughout the electrolyte sandwiched between asymmetric electrodes in the presence of contact. Furthermore, the pendant sulfonate anionic groups provide a hygroscopic nature to the electrolyte and the moisture uptake therefore determines the ion conduction in the electrolyte, giving wetness sensitivity to the smart skin. Assisted by the machine learning technology, a trifunctional smart skin system is realized having the advantages of self-power, simple structure, compacted size and multiple functionalities for simultaneously sensing the static pressure, dynamic forces and environmental relative humidity (RH).

### BRIEF DESCRIPTION OF THE DRAWINGS

This patent or application file contains at least one drawing executed in color. Copies of this patent or patent application publication with color drawing(s) will be provided by the Office upon request and payment of the necessary fee.

The foregoing and other objects and advantages of the present invention will become more apparent when considered in connection with the following detailed description and appended drawings in which like designations denote like elements in the various views, and wherein:

FIG. 1A is a diagram of the mechanism of tactile perception of human skin and the human nervous system and FIG. 1B is a diagram of the tactile perception of a self-powered smart skin;

FIG. 2A is a graph of the voltage output of a smart skin in the form of a smart finger under contact and release, FIG. 2B shows diagrams of the smart skin under pressing, releasing, contacting and releasing; FIG. 2C is a graph of output voltage versus pressure, FIG. 2D shows contact electrification outputs of the smart finger featuring anion conducting (green), cation conducting (orange), dual-ions conducting (grey), and non-conducting (black) electrolytes with changing relative humidities, FIG. 2E shows triboelectric output voltages versus frequency and FIG. 2F shows triboelectric output voltages versus relative humidity;

FIG. 3 shows the hygroelectric output voltage of the smart finger with increasing static pressure (raw data of FIG. 2C);

FIG. 4 is a Nyquist plot of the smart finger with differing applied pressure;

FIG. 5 show the response time for activation (left) and restoration (right) of the output voltage with a compression-release profile;

FIG. 6A is a graph of the output voltages of a smart finger with increasing dynamic pressure and FIG. 6B shows the dynamic pressure sensitivity of triboelectric signals;

FIG. 7 is a bar graph showing charge accumulation for triboelectric signals when the smart finger is driven by contact (pink) and separation (blue) at different humidities;

FIG. 8A shows the output voltage of a smart finger comprising two electrodes and different electrolytes, including an anion conductor (FAA), FIG. 8B shows the output voltage with a binary conductor (PVA/LiCl), FIG. 8C shows the output voltage with PVA but without salt and FIG. 8D shows the output voltage using a cation conductor (Nafion);

FIG. 9 shows the output voltages of the smart finger with increasing frequency of dynamic pressure;

FIG. 10 shows the output voltages of the smart finger with increasing relative humidity;

FIG. 11 shows the hygroscopic property of the electrolyte of the smart finger with relative humidity;

FIG. 12 shows the ionic conductivity property of the electrolyte of the smart finger with relative humidity wherein the insert illustrates dissociation of protons in Nafion induced by moisture;

FIG. 13 shows the working principle of the smart finger in the broad range of humidity;

FIG. 14A is a graph showing the output power of the smart finger depending on the load resistance for contact hygroelectric and separation triboelectric signals, FIG. 14B shows capacitive charging with individual contact hygroelectric and separation triboelectric signals (inset is an equivalent circuit for capacitive charging), FIG. 14C shows the lighting of a LED with forward (red) and reverse (blue) connections, FIG. 14D shows images of LED lighting with varying RHs and frequencies, FIG. 14E is a gray scale of the perceived brightness corresponding to the images in FIG. 14D using a home-built image analysis application, FIG. 14F is a comparison of calculated separation TE peak voltage and brightness where the solid line is the linear fit, FIG. 14G shows the discrimination capability of the smart finger, FIGS. 14H to 14J are confusion maps of the machine learning results for 8 humid, 9 pressure, and 6 vibrational conditions, respectively, FIG. 14K is a flow diagram of tactile perception from sensation to interpretation and FIG. 14L is a regression plot of the machine learning results of pre-trained model;

FIG. 15A shows the output voltage and current of contact hygroelectric signals as a function of load resistance and FIG. 15B shows the output voltage and current of separation triboelectric signals as a function of load resistance;

FIG. 16A shows snapshots or images of LED lighting with varying RHs and pressure and FIG. 16B shows grayscales of the perceived brightness corresponding to the images in FIG. 16A using a home-built image analysis application;

FIG. 17 is an image of a home-built image analysis application;

FIG. 18A is a diagram of a multiarray smart skin featuring a set of 5×5 electrodes and a single ion conducting electrolyte, FIG. 18B is a photograph of the fabricated multiarray smart skin showing its transparency, FIG. 18C is a photograph showing the flexibility of the smart skin, FIG. 18D is a chart showing the robustness and durability of the smart skins over 5000 cycles (inset images display the morphologies of the electrolyte before and after cycling, respectively), FIG. 18E is a diagram showing crosstalk between neighboring pixels and the response/relaxation time of the smart skin and FIG. 18F shows tactile perception mapping of the smart skin at different RHs while being pressed with the convex character patterns of ‘HKU’;

FIGS. 19A-C shows photographs of the convex character patterns of “HKU” in elevation view and perspective view, wherein FIG. 19A shows the letter H, FIG. 19B shows the letter K and FIG. 19C shows the letter U;

FIG. 20 shows the voltages of smart skins under the pressure with an “H” convex pattern, where the insert is the letter H on a corresponding 5×5 array;

FIG. 21 shows the voltages of smart skins under the pressure with a “K” convex pattern where the insert is the letter K on a corresponding 5×5 array; and

FIG. 22 shows the voltages of smart skins under the pressure with a “U” convex pattern where the insert is the letter U on a corresponding 5×5 array.

### DETAILED DESCRIPTION OF THE INVENTION

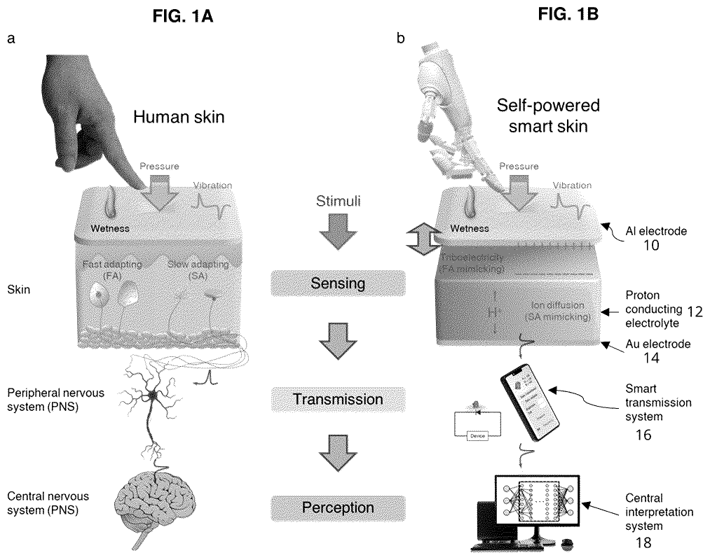

As indicated above, humans perceive environmental stimuli in conjunction with the somatosensory system in which mechano- and thermo-receptors in the skin encode the stimuli into electrical signals and the electrical signals are then evaluated in the sensory cortex (FIG. 1A) including the peripheral nervous system and the central nervous system. In particular, dynamic pressure and vibration (10 to 800 Hz) activate fast-adapting (FA) mechanoreceptors while the slow-adapting (SA) mechanoreceptors respond to the static pressure (0.1 to 100 kPa), [35-37] Wetness is perceived by mechanoreceptors complexed with thermoreceptors due in large part to the absence of hygroreceptors in the human somatosensory system. [2, 18]

Inspired by the human somatosensory system, a tactile smart finger was designed for pressure, vibration, and humidity perception based on triboelectricity and hygroelectricity, surpassing human tactile perception with regard to quantitative pressure, vibration, and humidity perception (FIG. 1B). The smart skin in the form of a smart finger is structurally composed of three layers: (1) a single-ion conducting electrolyte 12, which provides contact electrification and acts as a hygroscopic layer, (2) a gold (Au) electrode 14 and (3) a separable aluminum (Al) electrode 10 which serves as a counter triboelectrification layer. Upon applying a periodic force of compression and release to the Al electrode, the smart finger yields instantaneous voltage outputs arising from the contact electrification between the electrolyte and the Al electrode, allowing it to mimic the FA receptors in the human body. The SA receptors of the human body are emulated by the steady voltage outputs generated by ion diffusion throughout the electrolyte 12 sandwiched between asymmetric electrodes 10, 14 in the presence of contact. Furthermore, the electrolyte may be formed from pendant sulfonate anionic groups, which provide a hygroscopic nature to the electrolyte. The moisture uptake of the sulfonate anionic groups in the electrolyte therefore determine the ion conduction in the electrolyte, rendering the smart finger sensitive to wetness or humidity.

The triboelectric (TE) and hygroelectric (HE) signals from the smart finger are recorded by a smartphone 16, and the signals are transmitted to a central interpretation system 18 comprising a main server computer for interpretation with the help of machine learning, imitating the peripheral and central nervous systems.

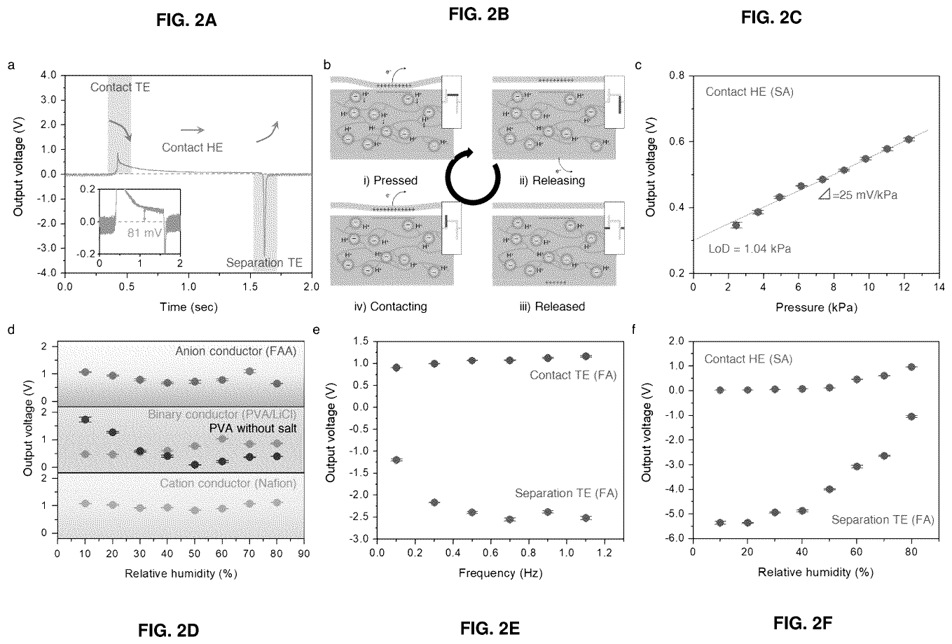

The smart finger may be exposed to a course of contacting or pressing (4.9 kPa) followed by release (FIG. 2A) in the presence of 50% relative humidity (RH) and analyzed to investigate the triboelectric and hygroelectric responses. The electrical outputs exhibit distinct instantaneous peaks of 0.9 and −3.4 V during contacting and release, respectively, and a stable voltage of 81 mV has been found under continuous pressing. The primary principle of the smart finger can be rationalized through the transient electron flow arising from the humidity-sensitive ion diffusion and contact-electrification of the electrolyte throughout the pressing, the releasing, and the contacting (FIG. 2B). In moderate humidity, the hygroscopic nature of the anionic electrolyte gives rise to moisture uptake, facilitating ion dissociation in the solid-state electrolyte, and thereby the concentration gradient of mobile charge across the electrolyte is formed by the asymmetric accessibility of moisture. The mobile charge diffusion in the electrolyte produces a continuous electron flow through the external circuit upon pressing the smart finger (FIG. 2B(i)), corresponding to a contact HE signal in FIG. 2A. The contact electrification at the interface between the electrolyte 12 and the separable Al electrode 14 creates surface charges, driving the development of the electric field at the interface, and resulting in transient electron flow and an instantaneous peak voltage peak under the separation (FIG. 2B(ii)), corresponding to separation TE in FIG. 2A. When the separable electrode approaches the electrolyte again (FIG. 2B(iii)), the electrons return back to the original electrode due to the fading of the electric field, resulting in the instantaneous voltage peak with reverse polarity when the electrode is released (FIG. 2B(iv)), corresponding to contact TE in FIG. 2A.

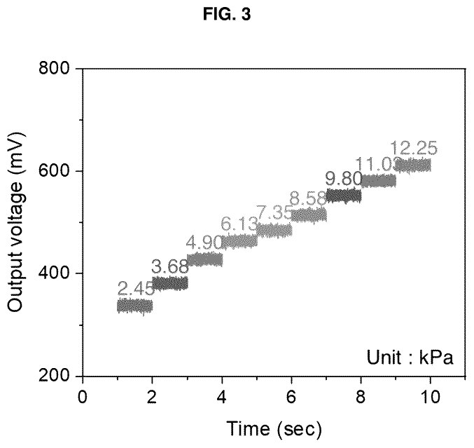

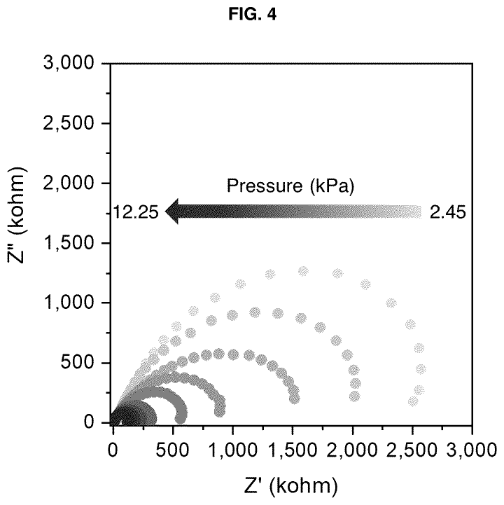

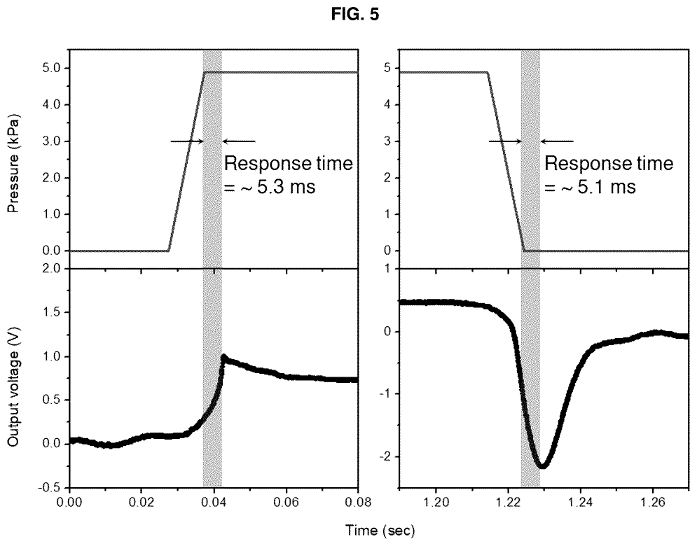

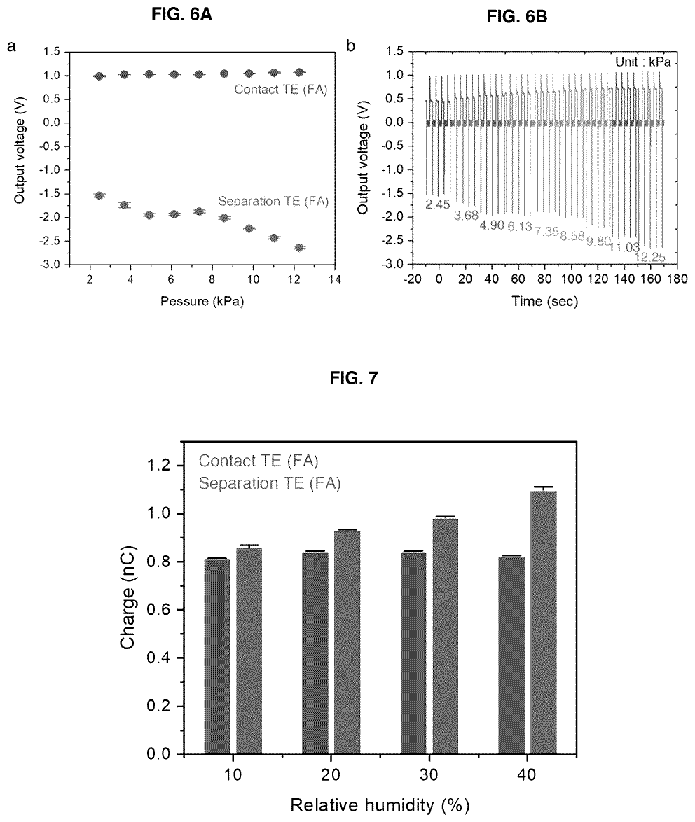

The sensitivity of the hygroelectric signal was investigated in the presence of differing static pressure on the smart finger at the RH of 70% (FIG. 3 and FIG. 6B), which is comparable to the typical human pressure perception range. [17, 39] The output voltage increased linearly with a sensitivity of 25 mV/kPa (FIG. 2C), which can be attributed to the greater tendency of interfacial resistance to decrease static pressure (FIG. 4). The limit of detection was approximated by LoD=3σ/S where σ is the standard deviation and S is sensitivity, and the LoD was accordingly determined to be 1.04 kPa, indicating that a small weight (0.1 N) on an area of 1 cm² can be detectable. The response time was confirmed to be approximately 5.3 and 5.1 ms for sensation and restoration, respectively (FIG. 5), denoting a vibration detection limit of up to −200 Hz. This trait successfully affords biomimetic slow-adapting mechanoreceptors given that the frequency range of human vibration perception by slow-adapting receptors (Merkel cell) is shown to be <100 Hz. [36] Further, the positive and negative triboelectric signals were analyzed upon applying the dynamic pressure from 2.45 to 12.25 kPa (FIG. 6A). As the effective area for contact electrification increases with dynamic pressure, the magnitude of negative outputs (separation TE) gradually becomes greater with increasing pressure, increasing up to 2.64 V under the 12.25 kPa. In contrast, the outputs of positive peaks (contact TE) remained stable regardless of the pressure applied (V_{PTE}=˜1 V). The triboelectric charges for contact and separation are calculated from the integration of a single current peak (FIG. 7), indicating that the charge accounting for separation (blue bar) increases with humidity while the contact charge (red bar) remains same. This trait is likely due to the fact that mobile cations in the electrolyte migrate from the surface to the stationary electrodes, so that the surface becomes more negative with increasing humidity, which dissipates the surface charge while the pressure on the device is being released.

FIG. 6B shows the dynamic pressure sensitivity of triboelectric signals in terms of voltage versus time at different pressures. The time scale of a single pressure is 20 seconds. When the same pressure is applied, the response voltage is stable.

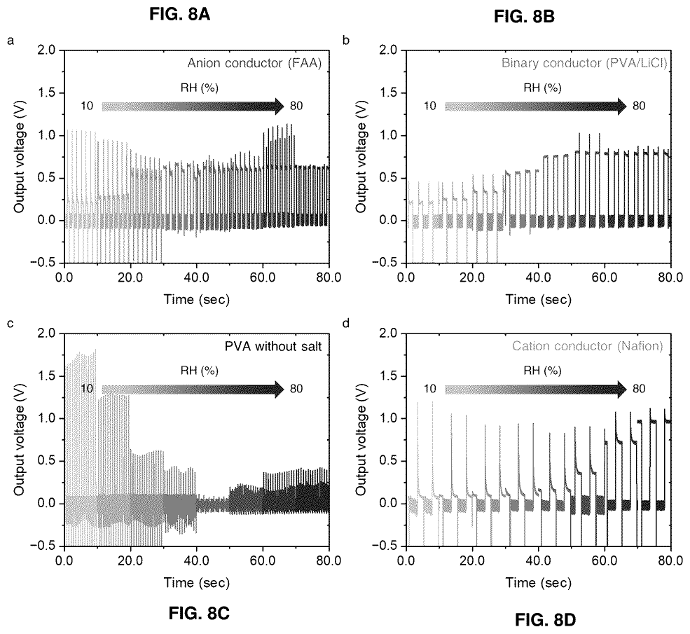

Devices featuring anion-conducting, binary ion-conducting, and cation-conducting electrolytes were prepared and placed in differing relative humidity. Remarkably, the output voltages of positive peaks were nearly stable for all marinated polymer electrolytes throughout the humidity range (FIG. 2D and FIG. 8A), indicating that the charges developed on the polymer surfaces are independent of the humidity. For comparison, the polymer electrolyte was evaluated in the absence of mobile ions, acting as a typical dielectric triboelectrification layer. Its positive voltage peaks substantially decreased with increasing humidity as the moisture facilitates surface charge dissipation. [40, 41] In contrast, either anions or cations in the marinated polymers are expected to be mobile, giving rise to the compensation for the surface charge while the devices are separated, resulting in the constant surface charges remaining regardless of pressure and humidity.

While FIG. 8A shows the output voltage of a smart finger comprising two electrodes and different electrolytes, including an anion conductor (FAA), FIG. 8B shows the output voltage with a binary conductor (PVA/LiCl). FIG. 8C shows the output voltage with PVA but without salt and FIG. 8D shows the output voltage using a cation conductor (Nafion). In FIG. 8C, pure PVA is used without salts which means in this case that the material theoretically has no ions. For the examples in FIGS. 8A, 8B and 8D, the material contains ion due to the added salts. FIGS. 8A-D shows that the output voltage of positive peaks are nearly stable for all samples with mobile ions. However, for PVA without ions, the positive peaks substantially decrease with increasing humidity as the moisture facilitates the dissipation of surface static charges. PVA (polyvinyl alcohol) is a non-ionic polymer but can absorb moisture from air and here is used as the matrix material.

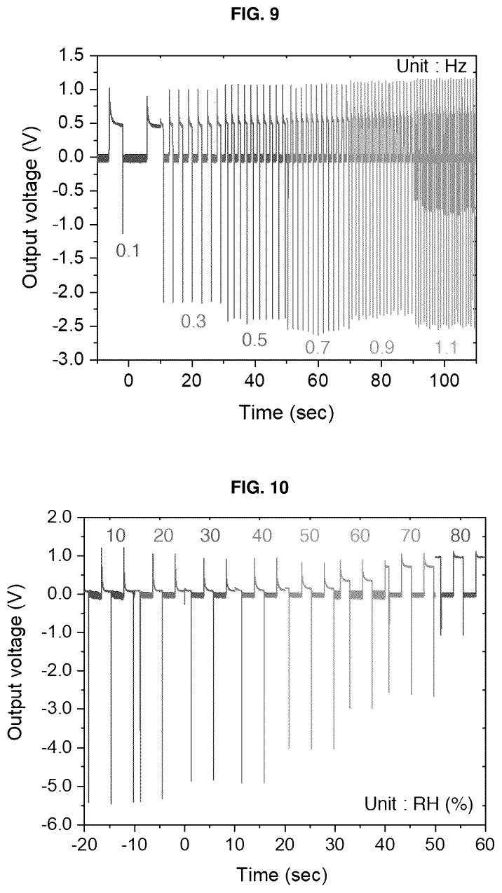

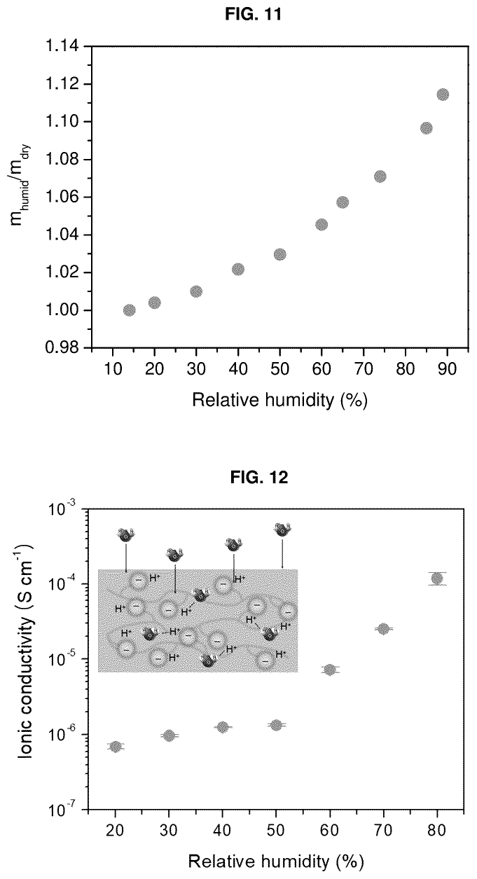

The triboelectric output voltages were investigated under a dynamic pressure of 4.9 kPa with variable frequency at the RH of 70% (FIG. 2E and FIG. 9). In FIG. 2E, with increased frequency, both positive and negative peaks are enlarged due to the insufficient relaxation of surface charge which leads to gradual surface charge accumulation upon repeating contact and separation. In FIG. 9, time does not have an effect on the voltage, but frequency does. In FIG. 9 time is just the time flow that is used to show the recorded voltage signal. The separation voltage peak of −1.2 V was achieved at an initial low frequency of 0.1 Hz, and the values increased to −2.5 V in the frequency ranges of 0.3 to 1.1 Hz. This frequency dependence is attributed to the insufficient relaxation of surface charge [24. 42], leading to surface charge accumulation upon repeated contact. Hence, a shorter relaxation time results in more significant charge accumulation at a higher frequency, demonstrating increased output voltage. Beyond the pressure and frequency sensitivity, the hygroscopic nature of the single-ion conducting electrolyte confers humidity sensitivity on the smart finger, as presented in FIG. 2F and FIG. 10. The measured output of hygroelectricity gradually increases with increasing RH from 10% to 80%, reaching 0.97 V at the RH of 80%. The single-ion conducting electrolyte has been shown to get heavy with an increase in the surrounding humidity (FIG. 11) due largely to the moisture uptake. Polar solvating water facilitates ion dissociation and migration in a solid electrolyte [43, 44], and indeed the ion transport was found to be faster with increasing RH (FIG. 12), helping to rationalize the observed humidity sensitivity of the smart finger. The insert in FIG. 12 illustrates dissociation of protons in Nafion induced by moisture.

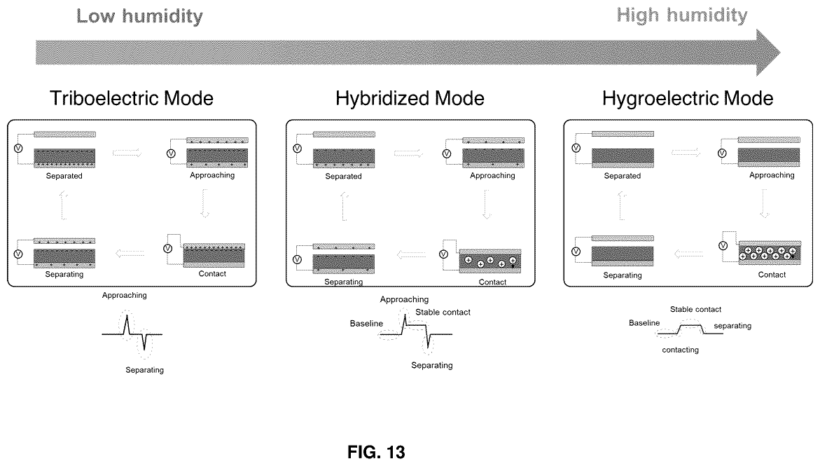

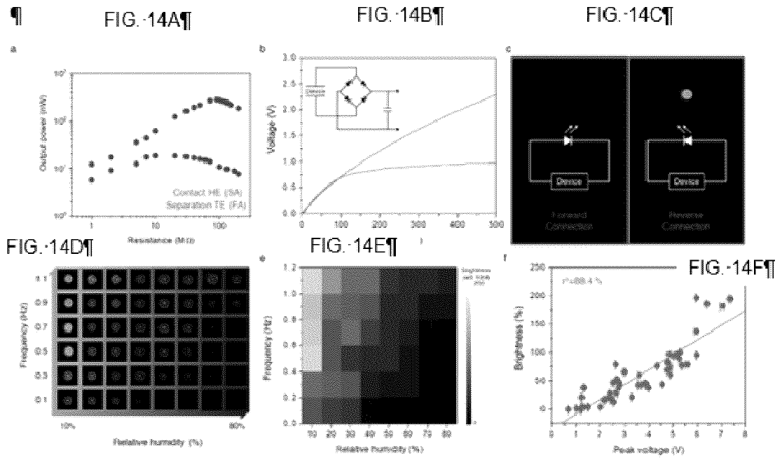

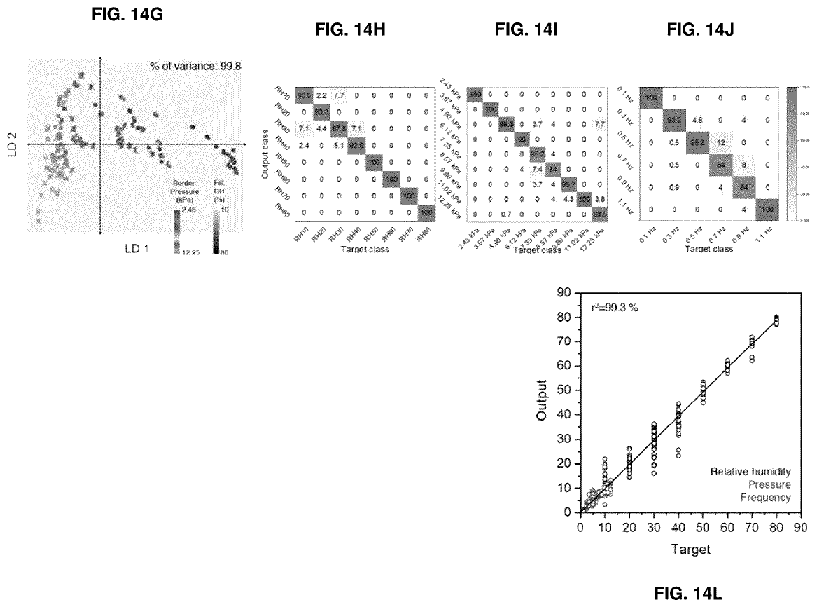

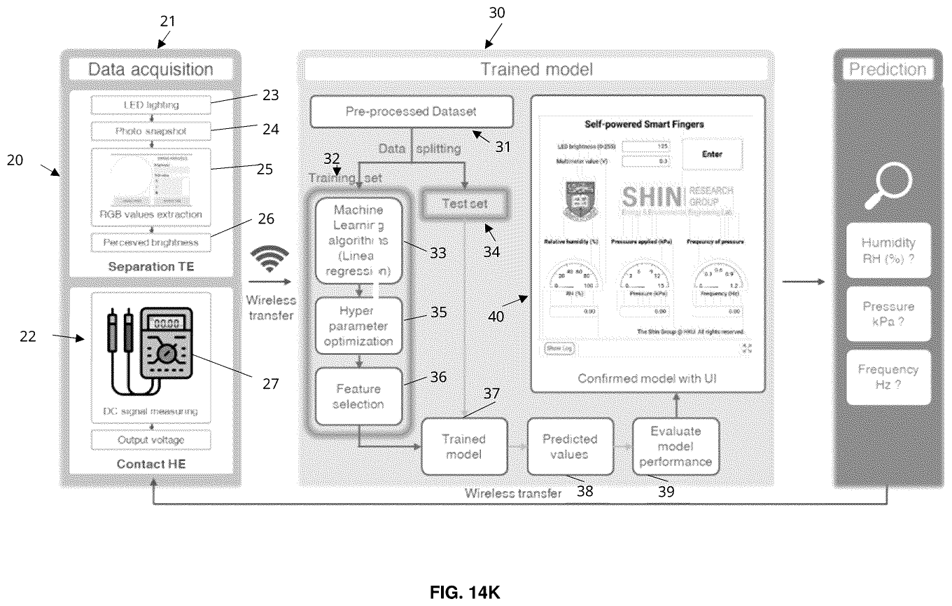

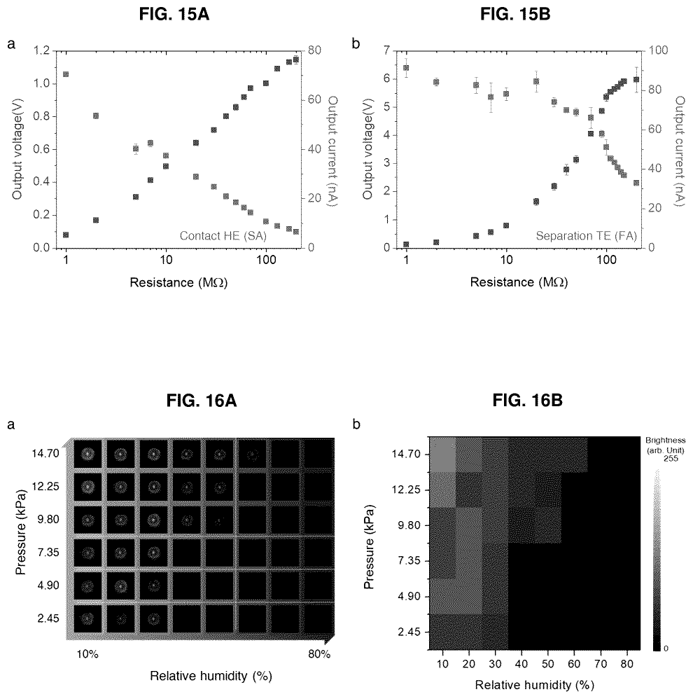

Ultimately, the different sensitivities to multiple stimuli, including pressure, vibration, and humidity, render this smart finger a promising platform for tactile perception by characterizing individual behaviors (FIG. 13). First the self-powering capabilities of the smart finger were demonstrated, and the power curves obtained from the different humidities are shown in FIG. 14A and FIG. 15. The maximum powers generated in RH 10 and 80% were 305 nW (at the load of 50 MΩ) and 25 nW (at the load of 20 MΩ), respectively, which stably charge a 10 μF capacitor up to 2.3 and 0.97 V within 500 seconds at RH 10 and 80%, respectively (FIG. 14B). It is worth noting that the electrical power generated at RH 10% mainly arises from triboelectricity, whereas hygroelectricity is the main contributor to yielding the power at RH 80%, suggesting that energy delivery from both triboelectricity and hygroelectricity is stable for self-powered smart finger operation. Furthermore, a light-emitting diode (LED) was successfully lit under the reverse connection while the forward connection produced no noticeable light (FIG. 14C), revealing that the separation TE peak can be separated from the single cycled electric signal using the LED lighting. The snapshots of the green LED with respect to different RHs, frequencies, and pressure are presented in FIG. 14D and FIG. 16A. Slow vibration, high humidity and low pressure resulted in reduced brightness, and an increase in the vibration and pressure, and a dry environment boosted brightness.

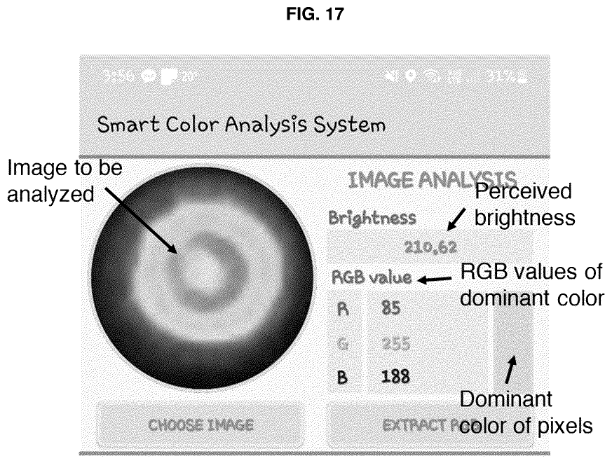

To gain further insight into the quantitative brightness of LEDs, a home-built image analysis application was employed in which the 8-bit RGB color components were extracted from the photographs taken by the mobile phone (FIG. 17). The perceived brightness (PB) was approximated by the equation

$$PB = \sqrt{0.299 {R}^{2} + 0.587 {G}^{2} + 0.114 {B}^{2}} [ 45 ]$$

where R, G, B denote the values of RGB color components in 0 to 255 scale, respectively. The LED images in FIG. 14D and FIG. 16A are converted into the brightness matrix, as plotted in FIG. 14E and FIG. 16B, showing that the PB values correlated to each LED luminescent. Moreover, the PB values displayed a high degree of correlation (r=88.4%) with 95% confidence interval to the separation TE peaks (FIG. 14F), which together imply that the separation TE signal of the smart finger can be successfully obtained from the electrical signal using the PB of green LEDs reversely connected.

Machine learning has been a well-established tool for building models from sample data without explicit programming, thus facilitating the prediction of new data behavior comprising multidimensional features. [46, 47] In developing the present invention, multiple features, including contact TE, contact HE, separation TE, pressure, frequency, and humidity, were chosen for extraction in a machine learning algorithm. To identify the categorization of multiple features, the first aim was to convert high-dimensional data into two-dimensional space using linear discriminant analysis (LDA) in which the distance between each data point in the category is minimized while the category distance is maximized. As shown in FIG. 14G the clear discrimination between a complex of humid, pressure, and vibrational conditions can be achieved. Low RH and vibrational conditions tend to group together on the negative side of the first and second discriminant factors, respectively. Also, low pressure tended to cluster on the negative side of the second discriminant factor, whereas on the positive side of the second factor the high pressure results are clustered. The first two discriminant factors account for 99.8% of the variance. The confusion matrices of 8 humid, 9 pressure, and 6 vibrational conditions are presented in FIGS. 14H, 14I and 14J, respectively, and high prediction accuracy was achieved for all matrices. Overall, data clustering demonstrates discrimination capability and high reproducibility, suggesting potential applications of the smart fingers for accurate sensing of pressure, vibration, and humidity.

On the basis of the pressure, vibration, and humidity discrimination capability of smart fingers outlined above, the real-world tactile perception of smart fingers incorporating machine learning for pressure, vibration, and humidity sensing is demonstrated. FIG. 14K illustrates a flowchart detailing tactile perception using smart fingers with the help of a home built image analysis application and machine learning. First, a pre-trained model was developed using the collected data of known conditions in order to save calculation time and memory space for machine learning in a central computer.

In the trained model 30 the dataset was preprocessed at 31 to label the feature matrix and it was split into training (80%) and test (20%) sets. With the linear regression algorithm based on supervised machine learning, the relationship between dependent and independent features was successfully trained. In particular, the training set 32 was applied to machine learning algorithms at 33 after which the set was exposed to hyper-parameter optimization at 35 and feature selection at 36. This formed the trained model 37 where the training was validified by the test dataset 34. The regression plot shown in FIG. 14L exhibits the high accuracy of the pre-trained model with a high degree of correlation (r=99.3%).

Next, the smart finger acquires the contact HE 22 and separation TE 20 signals using a smart transmission handheld data acquisition device 21 (e.g., a smartphone). The separation TE involved using LED lighting at 23 to take a photo snapshot at 24 from which RGB values were extracted at 25. From these values perceived brightness was determined at 26. Contact He was determined using a DC signal measuring meter 27 to provide an output voltage. The perceived brightness and output voltage signals are then transmitted to the central computer 30 via Wi-Fi for perception in the pre-trained model. The perception results are set to be simultaneously displayed on the screens of both the central computer 30 and the handheld device 21. The results from the trained model 37 are used to determine predicted values 38, whose accuracy is evaluated at 39 and confirmed on a user interface (UI) 40. Four conditions were chosen to test the perception accuracy of the smart finger for relative humidity, pressure, frequency, and the recognition results are presented in Table 1.

TABLE 1
The current signals measured at RH50% with 4.9 kPa
and 0.3 Hz mechanical contact and separation.

| | Conditions applied | | | Conditions predicted | | |
|---|---|---|---|---|---|---|
| Sample | RH | Pressure | Frequency | RH | Pressure | Frequency |
| No. | (%) | (kPa) | (Hz) | (%) | (kPa) | (Hz) |
| 1 | 24 | 4.9 | 0.3 | 29.29 | 5.78 | 0.32 |
| 2 | 25 | 6.9 | 0.5 | 28.15 | 7.93 | 0.39 |
| 3 | 33 | 8.6 | 0.7 | 32.29 | 9.11 | 0.69 |
| 4 | 50 | 6.1 | 1.1 | 64.65 | 7.12 | 1.07 |

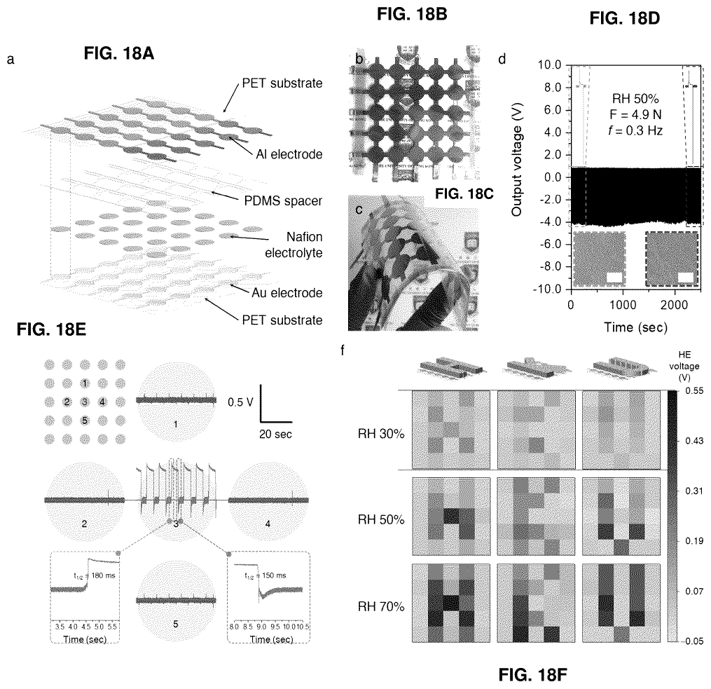

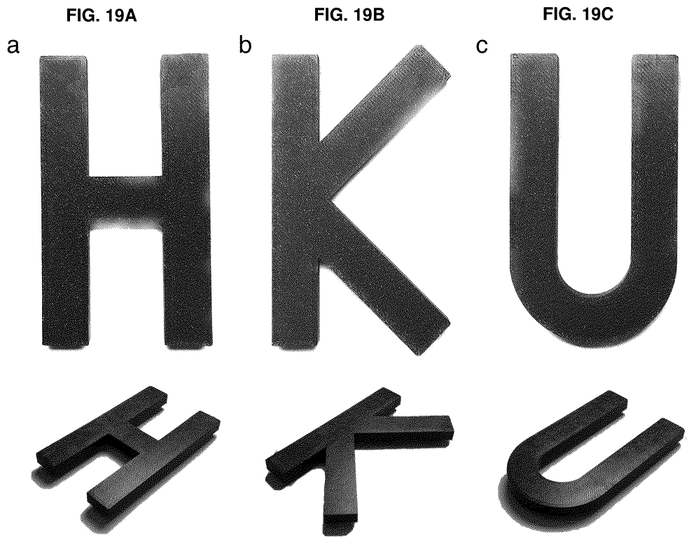

Beyond the tactile perception of the localized region, a multiarray of smart skin comprising 25 pixels of aluminum electrodes, Nafion electrolytes, and gold electrodes was constructed to investigate the tactile perception performance of smart skin in line with spatial regions (FIG. 18A). Nafion is a brand name for a sulfonated tetrafluoroethylene based fluoropolymer-copolymer. The electrode arrays were fabricated by a masked thermal evaporation technique. A 5 by 5 electrode array pattern was first defined on the paper mask, and the 100-nm-thick gold or aluminum films were then deposited on the polyethylene terephthalate (PET) substrate covered by a stainless steel mask using a thermal evaporator. The Nafion electrolyte was punched into a 10 mm circular shape, and then placed on the gold electrode. The multiarray smart skin was obtained by covering the electrolyte with an aluminum electrode pattern on the PET substrate. Polydimethylsiloxane (PDMS) spacers were located on the electrode substrate to maintain a defined gap between the electrolyte and the aluminum electrode. Photographic images of a fabricated smart finger array are presented in FIGS. 18B and 18C, which show the semi-transparency and high flexibility of the device of the present invention, suggesting potential applications such as wearable electronic skins and biomedical sensors. The long-term stability of the device was determined over the course of 5,000 compression-release cycles, as shown in FIG. 18D, which appears to show it to be stable compared with its initial voltage level. The insets of FIG. 18D demonstrate the outstanding durability and robustness of the smart fingers, revealed by scanning electron microscopy.

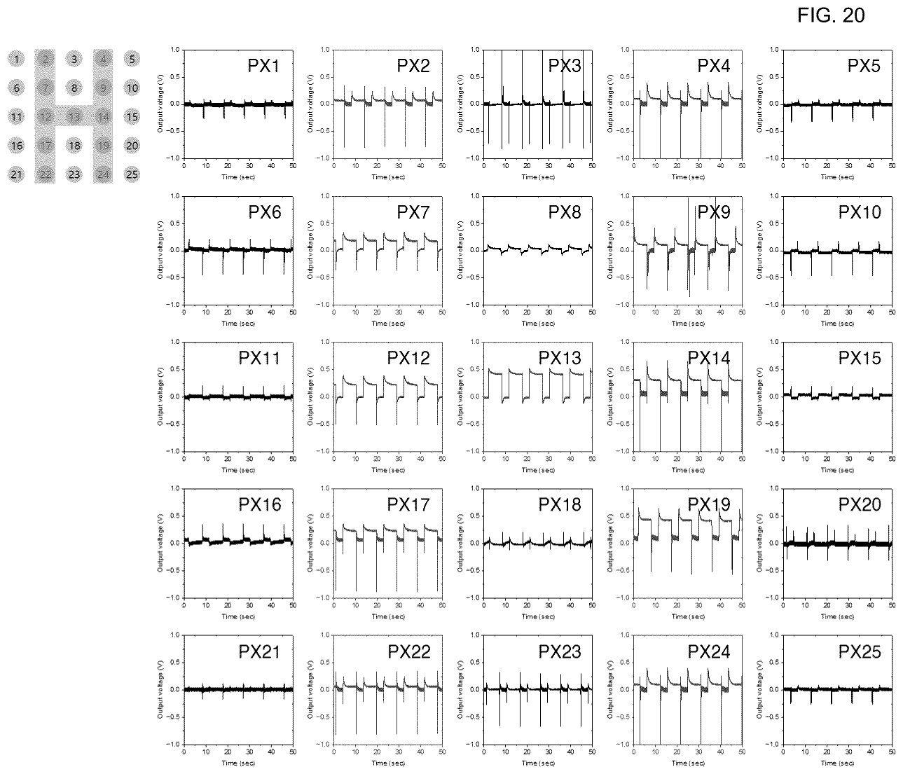

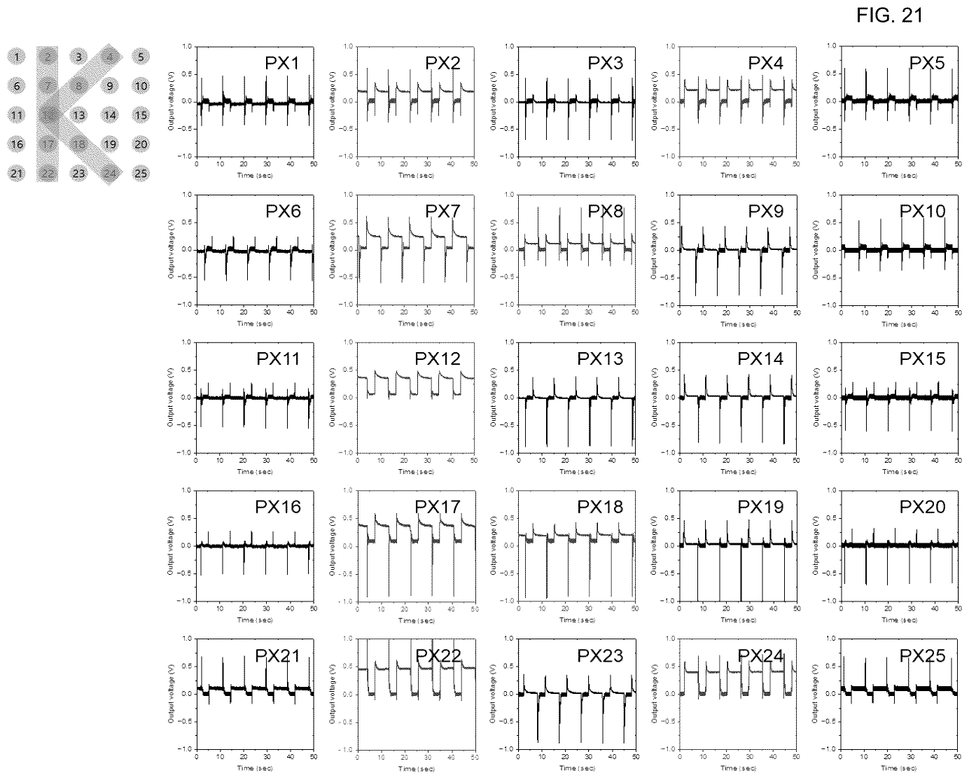

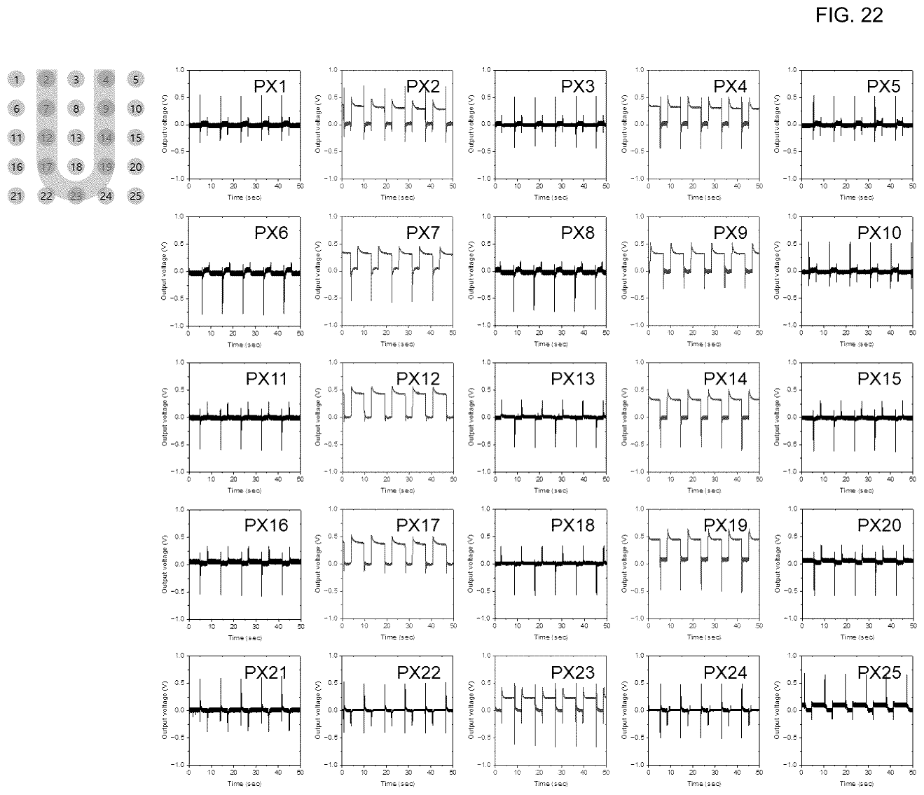

The voltage signals of the nearest pixels (1, 2, 4 and 5) were investigated when the center pixel (3) was subjected to compression (FIG. 18E). This showed a little crosstalk between adjacent pixels. The triboelectric signals were observed for some adjacent pixels (1 and 5), which is likely attributed to the electrolyte-electrode distance change in the nearest pixels during compression. Response and relaxation times of approximately 150 ms were measured from the enlarged plots in FIG. 18E. Lastly, the convex character patterns of “HKU” were directly pressed on the smart skin to demonstrate a 2-dimensional mapping of spatial stress (FIG. 19), and the resultant contact HE signals of the device at applied RHs of 30, 50, 70% under the compressive force of 19.6 N were recorded using a multichannel oscilloscope (FIG. 18F and FIGS. 20-22). The mapping images unambiguously show the “HKU” characters and the characters became more apparent at the elevated RHs, holding promise for potential applications of the smart skin array as electronic skin and signal display. It is worth mentioning that the smart skin can easily be scaled-up or down due in large part to its simple device architecture, indicating further room for resolution improvement down to 50 μm with the aid of photolithographic techniques.

The present invention provides a route for imitating multimodal human tactile perception from sensation to interpretation on the basis of triboelectric/hygroelectric sensing and a machine learning algorithm. The contact electrification of the single-ion conducting electrolyte and separatable aluminum electrode facilitates the dynamic mechanical stimuli sensing, while the ion migration throughout the electrolyte enables the static sensing. Further, the hygroscopic nature of electrolytes endows them with the capability of humidity sensing. The smart skin comprising the single-ion conducting electrolyte and two electrodes converted static/dynamic mechanical stimuli and wetness into electrical signals. The encoded signals of the smart skin were successfully interpreted into RHs, pressure, and vibration with an accuracy of 84.0-100.0% using the handheld device and machine learning, demonstrating a tactile perception of both local and spatial sensations. The smart skin provides multiple advantages, including a simple fabrication, compact size, fast response, high accuracy, self-powering, and multimodal sense. Moving forward, spatial resolution and miniaturization are required to further improve the device in order to incorporate it into robots or even humans with the help of advanced photolithographic technologies. The smart chips integrating sensing modules, LEDs, image analysis modules, and wireless transmitters/receivers make them “smarter” and will lead to more applications in robotics, prosthetics, healthcare, human-machine interface, and intelligent industry.

The fabrication of the tactile perception smart finger begins with a basic structure composed of a single ion conducting electrolyte sandwiched by gold and aluminum electrodes. A 100 nm gold layer is deposited on a piece of 2 cm×2 cm Nafion NR-211 membrane (Dupont De Nemours) electrolyte with a thickness of 25 μm using a thermal evaporator (Beijing Technol. Science Co., LTD ZHD-300M2). An aluminum foil is used as the counter electrode. For the construction of the 5×5 sensory array, a 100-nm-metal layer (i.e. gold or aluminum) is first coated on a oxygen plasma-treated PET substrate that is covered by a stainless-steel mask to create a customized pixel pattern. The Nafion 211 film is attached to gold electrode by pressing it under 10 kPa of force overnight at RH 50%. Then PDMS pieces with a thickness of 2 mm and a diameter of 3 mm are sandwiched between the two electrodes to serve as the spacers. Each pixel is circularly shaped with a diameter of 9 mm and a center-to-center distance of 15.5 mm.

In order to characterize the smart finger, periodic stress was applied to the smart finger by using a pushing tester (Junil Tech. JIPT-120) accommodated in a digitalized humidity controller (Terra Universal 1911-24D). An oscilloscope (Agilent DSO-X-2014A) equipped with a preamplifier (SRS SR-570) was used for voltage and current measurements throughout this research. The weight change of the Nafion film after moisture uptake was measured using a semi-microbalance (Sartorius Cubis® II MCA125S-2S00-I). The ionic conductivity of Nafion film was determined using Admiral Squidstat Plus potentiostat with impedance spectroscopy capability, over the frequency range from 0.1 Hz to 1 MHz The non-blocking stainless-steel electrodes were used to assemble symmetric electrode/electrolyte/electrode cells that were packed into stainless-steel (SS) electrodes using an AC impedance method. All tests were conducted at 25±2° C. The surface morphology of the Nafion film before and after long-term operation was investigated using a field-emission scanning electron microscope (Hitachi S4800-7952).

Image analysis application software was created for the self-powered smart finger. An LED was directly connected to the smart finger to obtain the separation TE signal from the electrical outputs individually. The LED was positioned in a dark chamber with an optical opening where an Android smartphone (Samsung Galaxy Note 10+) was mounted to take a video of LED lightning. A home-built image analysis system was developed for the quantitative characterization of LED brightness, which is termed ‘Smart Color Analysis System (SCAS)’. The SCAS is an Android software application built using Android Studio. This application was built to systematically extract the RGB components from a snapshot of the video, followed by perceived brightness. The SCAS workflow is detailed as follows:

Image loading The user can load the snapshot image of LED lighting for the RGB components extraction. See FIG. 14K.

Image preprocessing Once the user loads the snapshot image to be analyzed, it can be resized and cropped to remove the background.

Image analysis The truncated image is converted into a matrix containing the RGB and brightness values of each pixel. The brightness was estimated by the equation

$$B = \sqrt{0.299 {R}^{2} + 0.587 {G}^{2} + 0.114 {B}^{2}} [ 45 ]$$

where R, G, B indicate the values of RGB color components on a 0 to 255 scale, respectively. The matrix is processed to find the most frequent color from all pixels over the image selected. First, the occurrence of individual RGB components is counted and sorted in descending order. Six color matrices are chosen, being the most frequently observed in the image by sorting them in the orders of RGB, RBG, GRB, GBR, BGR, and BRG. The brightest color components are selected as a representative color of the image. In this software, the pixels featuring a brightness of >15 are analyzed to filter the black background.

Supervised machine learning was employed to predict the pressure, vibration, and humidity from responses of the smart finger using a MATLAB programming language (Mathworks Inc., Natick, MA). See FIG. 14K. For the classification of individual RH, pressure, and frequency, the ‘patternnet’ algorithm was employed to train the neural network in which the preprocessed data was split into 70:15:15 by percent for training, validation, and testing. In order to quantitatively predict the RH, pressure, and frequency values from the brightness and output voltage, two pre-trained models were developed to train the network by the ‘fitnet’ algorithm: Brightness/contact HE and contact HE/separation TE/RH/pressure/frequency. With two models, the application with a user interface was constructed for real-time analysis of smart skin signals. Once the user inputs the brightness and separation TE value into the application, the contact HE value will be estimated from the pre-trained model, and then RH, pressure, and frequency are predicted from contact HE and separation TE signals.

The above are only specific implementations of the invention and are not intended to limit the scope of protection of the invention. Any modifications or substitutes apparent to those skilled in the art shall fall within the scope of protection of the invention. Therefore, the protected scope of the invention shall be subject to the scope of protection of the claims.

### REFERENCES

The cited references in this application are incorporated herein by reference in their entirety and are as follows:
[1] Lumpkin, E. A. & Caterina, M. J. Mechanisms of sensory transduction in the skin. Nature 445, 858-865 (2007).
[2] Filingeri, D. & Havenith, G. Human skin wetness perception: psychophysical and neurophysiological bases. Temperature 2, 86-104 (2015).
[3] Chen, T. et al. Triboelectric Self-Powered Wearable Flexible Patch as 3D Motion Control Interface for Robotic Manipulator. ACS Nano 12, 11561-11571 (2018).
[4] Jin, T. et al. Triboelectric nanogenerator sensors for soft robotics aiming at digital twin applications. Nat. Commun. 11, 5381 (2020).
[5] Sun, Z. et al. Artificial Intelligence of Things (AIoT) Enabled Virtual Shop Applications Using Self-Powered Sensor Enhanced Soft Robotic Manipulator. Adv. Sci. 8, 2100230 (2021).
[6] Kim, J. et al. Stretchable silicon nanoribbon electronics for skin prosthesis. Nat. Commun. 5, 5747 (2014).
[7] Wang, S. et al. Skin electronics from scalable fabrication of an intrinsically stretchable transistor array. Nature 555, 83-88 (2018).
[8] Hammock, M. L., Chortos, A., Tee, B. C. K., Tok, J. B. H. & Bao, Z. 25th Anniversary Article: The Evolution of Electronic Skin (E-Skin): A Brief History, Design Considerations, and Recent Progress. Adv. Mater. 25, 5997-6038 (2013).
[9] Beker, L. et al. A bioinspired stretchable membrane-based compliance sensor. PNAS 117, 11314-11320 (2020).
[10] Park, J., Kim, M., Lee, Y, Lee, H. S. & Ko, H. Fingertip skin-inspired microstructured ferroelectric skins discriminate static/dynamic pressure and temperature stimuli. Sci. Adv. 1, e1500661 (2015).
[11] Zhang, F., Zang, Y, Huang, D., Di, C.-a. & Zhu, D. Flexible and self-powered temperature-pressure dual-parameter sensors using microstructure-frame-supported organic thermoelectric materials. Nat. Commun. 6, 8356 (2015).
[12] Yang, J. et al. Flexible Smart Noncontact Control Systems with Ultrasensitive Humidity Sensors. Small 15, 1902801 (2019).
[13] Tolvanen, J., Hannu, J. & Jantunen, H. Hybrid Foam Pressure Sensor Utilizing Piezoresistive and Capacitive Sensing Mechanisms. IEEE Sens. J. 17, 4735-4746 (2017).
[14] Chen, H. et al. Fingertip-inspired electronic skin based on triboelectric sliding sensing and porous piezoresistive pressure detection. Nano Energy 40, 65-72 (2017).
[15] Narita, F. et al. A Review of Piezoelectric and Magnetostrictive Biosensor Materials for Detection of COVID-19 and Other Viruses. Adv. Mater. 33, 2005448 (2021).
[16] Kim, Y-G., Song, J.-H., Hong, S. & Ahn, S.-H. Piezoelectric strain sensor with high sensitivity and high stretchability based on kirigami design cutting. npj Flexible Electron. 6, 52 (2022).
[17] Mannsfeld, S. C. B. et al. Highly sensitive flexible pressure sensors with microstructured rubber dielectric layers. Nat. Mater. 9, 859-864 (2010).
[18] Xie, M. et al. Flexible Multifunctional Sensors for Wearable and Robotic Applications. Adv. Mater. Technol. 4, 1800626 (2019).
[19] Shin, Y-E. et al. Self-powered triboelectric/pyroelectric multimodal sensors with enhanced performances and decoupled multiple stimuli. Nano Energy 72, 104671 (2020).
[20] Gong, S. et al. A wearable and highly sensitive pressure sensor with ultrathin gold nanowires. Nat. Commun. 5, 3132 (2014).
[21] Zhu, B. et al. Microstructured Graphene Arrays for Highly Sensitive Flexible Tactile Sensors. Small 10, 3625-3631 (2014).
[22] Chen, X. et al. A chaotic pendulum triboelectric-electromagnetic hybridized nanogenerator for wave energy scavenging and self-powered wireless sensing system. Nano Energy 69, 104440 (2020).
[23] Li, X. et al. Networks of High Performance Triboelectric Nanogenerators Based on Liquid-Solid Interface Contact Electrification for Harvesting Low-Frequency Blue Energy. Adv. Energy Mater. 8, 1800705 (2018).
[24] Jeong, J. et al. A Sustainable and Flexible Microbrush-Faced Triboelectric Generator for Portable/Wearable Applications. Adv. Mater. 33, 2102530 (2021).
[25] Amangeldinova, Y et al. in Micromachines, Vol. 12 (2021).
[26] Zhang, Y, Fu, S.-C., Chan, K. C., Shin, D.-M. & Chao, C. Y. H. Boosting power output of flutter-driven triboelectric nanogenerator by flexible flagpole. Nano Energy 88, 106284 (2021).
[27] Kim, T. et al. Versatile nanodot-patterned Gore-Tex fabric for multiple energy harvesting in wearable and aerodynamic nanogenerators. Nano Energy 54, 209-217 (2018).
[28] Phan, H. et al. Aerodynamic and aeroelastic flutters driven triboelectric nanogenerators for harvesting broadband airflow energy. Nano Energy 33, 476-484 (2017).
[29] Meng, K. et al. Flexible Weaving Constructed Self-Powered Pressure Sensor Enabling Continuous Diagnosis of Cardiovascular Disease and Measurement of Cuffless Blood Pressure. Adv. Funct. Mater. 29, 1806388 (2019).
[30] Zhao, L. et al. Reversible Conversion between Schottky and Ohmic Contacts for Highly Sensitive, Multifunctional Biosensors. Adv. Funct. Mater. 30, 1907999 (2020).
[31] Ma, Y et al. Self-Powered, One-Stop, and Multifunctional Implantable Triboelectric Active Sensor for Real-Time Biomedical Monitoring. Nano Lett. 16, 6042-6051 (2016).
[32] Sun, J., Yang, A., Zhao, C., Liu, F. & Li, Z. Recent progress of nanogenerators acting as biomedical sensors in vivo. Sci. Bull. 64, 1336-1347 (2019).
[33] Wu, C., Wang, A. C., Ding, W., Guo, H. & Wang, Z. L. Triboelectric Nanogenerator: A Foundation of the Energy for the New Era. Adv. Energy Mater. 9, 1802906 (2019).
[34] Wang, Z. L. Triboelectric Nanogenerator (TENG)-Sparking an Energy and Sensor Revolution. Adv. Energy Mater. 10, 2000137 (2020).
[35] Abraira, Victoria E. & Ginty, David D. The Sensory Neurons of Touch. Neuron 79, 618-639 (2013).
[36] Wang, M. et al. Artificial Skin Perception. Adv. Mater. 33, 2003014 (2021).
[37] Chun, S. et al. Self-Powered Pressure- and Vibration-Sensitive Tactile Sensors for Learning Technique-Based Neural Finger Skin. Nano Lett. 19, 3305-3312 (2019).
[38] Lee, Y et al. Flexible Pyroresistive Graphene Composites for Artificial Thermosensation Differentiating Materials and Solvent Types. ACS Nano 16, 1208-1219 (2022).
[39] Chun, S., Kim, Y, Jung, H. & Park, W. A flexible graphene touch sensor in the general human touch range. Appl. Phys. Lett. 105, 041907 (2014).
[40] Nemeth, E., Albrecht, V., Schubert, G. & Simon, F. Polymer tribo-electric charging: dependence on thermodynamic surface properties and relative humidity. J. Electrostat. 58, 3-16 (2003).
[41] Nguyen, V. & Yang, R. Effect of humidity and pressure on the triboelectric nanogenerator. Nano Energy 2, 604-608 (2013).
[42] Fan, F.-R., Tian, Z.-Q. & Lin Wang, Z. Flexible triboelectric generator. Nano Energy 1, 328-334 (2012).
[43] Shin, D.-M. et al. A Single-Ion Conducting Borate Network Polymer as a Viable Quasi-Solid Electrolyte for Lithium Metal Batteries. Adv. Mater. 32, 1905771 (2020).
[44] Paren, B. A. et al. Superionic Li-Ion Transport in a Single-Ion Conducting Polymer Blend Electrolyte. Macromolecules 55, 4692-4702 (2022).
[45] Finley, D. R. HSP Color Model Alternative to HSV (HSB) and HSL. https://alienryderflex.com/hsp.html (2006).
[46] Zhou, Z. et al. Sign-to-speech translation using machine-learning-assisted stretchable sensor arrays. Nat. Electron. 3, 571-578 (2020).
[47] Qu, X. et al. Artificial tactile perception smart finger for material identification based on triboelectric sensing. Sci. Adv. 8, eabg2521 (2022).

While the invention is explained in relation to certain embodiments, it is to be understood that various modifications thereof will become apparent to those skilled in the art upon reading the specification. Therefore, it is to be understood that the invention disclosed herein is intended to cover such modifications as fall within the scope of the appended claims.

1. A smart skin system comprising:
tactile sensors that mimic the functions of human skin by sensing pressure, vibration and humidity simultaneously and generate electric signals as a result thereof; and
a machine learning assisted data processor that interprets the electric signals from the sensors and quantitively perceives the stimulation in terms of pressure, vibration, and environmental humidity.

2. The smart skin system of claim 1 wherein the sensor structurally comprises:
a single-ion conducting electrolyte, which provides contact electrification, serves as a hygroscopic layer and produces DC hygroelectric signals in response to humidity;
a gold electrode; and
a separatable aluminium electrode as a counter triboelectrification layer that produces AC triboelectric signals in response to contact.

3. The smart skin system of claim 2 wherein triboelectric and hygroelectric signals from the sensors are recorded and then transmitted to a main server computer for interpretation with the help of machine learning, imitating the peripheral and central nervous systems of a human.

4. The smart skin system of claim 2 wherein the gold layer is 100 nm thick deposited on the electrolyte, which is a piece of 2 cm×2 cm Nafion with a thickness of 25 and the aluminum electrode is aluminum foil.

5. The smart skin system of claim 2 wherein the electrolyte is formed from pendant sulfonate anionic groups, which provide a hygroscopic nature to the electrolyte.

6. The smart skin system of claim 2 in which the contact is repeated compression and release of the sensor.

7. The smart skin system of claim 2 in which the hygroscopic contact electrification layer is integrated into triboelectric nanogenerators (TENGs) so the sensor is sensitive to static stimuli in addition to the dynamic stimuli.

8. The smart skin system of claim 2 wherein the machine learning assisted data processor operates according to the following steps:
developing a pre-trained model using a collected dataset of known conditions;
pre-processing the dataset to label a feature matrix and split the dataset into training and test sets;
training the relationship between dependent and independent features using a linear regression algorithm based on supervised machine learning to obtain a pre-trained model;
validifying the test dataset;
acquiring the contact hygroelectric and separation triboelectric signals in terms of perceived brightness and output voltage, and
transmitting the signals to a central computer; and
processing the signals in the central computer for perception in the pre-trained model.

9. The smart skin system of claim 8 wherein in the pre-processing step the dataset is split into 80% training sets and 20% test sets.

10. The smart skin system of claim 8 wherein the contact hygroelectric and separation triboelectric signals are acquired by a handheld device and the handheld device transmits the signals to the central computer via Wi-Fi.

11. The smart skin system of claim 10 further including the step of simultaneously displaying the perception results on screens of both the central computer and the handheld device.

12. The smart skin system of claim 11 wherein the handheld device is a smart device.

13. A multi-array smart skin comprising:
25 pixels of aluminum electrodes in the form of a 5 by 5 electrode array pattern;
a Nafion, sulfonated tetrafluoroethylene based fluoropolymer-copolymer, electrolytes, and
gold electrodes.

14. The multi-array smart skin of claim 13 wherein the electrode arrays were fabricated by a masked thermal evaporation technique comprising the steps of:
defining on a paper mask the 5 by 5 electrode array pattern;
depositing a 100-nm-thick gold or aluminum film on a polyethylene terephthalate (PET) substrate covered by a stainless steel mask using a thermal evaporator;
punching a 10 mm circular shape on the Nafion electrolyte, and then placing the electrolyte on the gold electrode;
covering the electrolyte with an aluminum electrode pattern; and
locating Polydimethylsiloxane (PDMS) spacers on the aluminum electrode substrate to maintain a defined gap between the electrolyte and the aluminum electrode.

15. The multi-array smart skin of claim 13 wherein the 5×5 sensory array is formed by the process of:
coating a 100-nm-metal layer (i.e. gold or aluminum) on a oxygen plasma-treated PET substrate that is covered by a stainless-steel mask to create a customized pixel pattern;
attaching a Nafion film to the gold electrode by pressing it under 10 kPa of force overnight at RH 50%;
sandwiching PDMS pieces with a thickness of 2 mm and a diameter of 3 mm between the two electrodes to serve as the spacers; and
circularly shaping each pixel with a diameter of 9 mm and a center-to-center distance of 15.5 mm.

16. The smart skin of claim 8 wherein after acquiring the contact hygroelectric and separation triboelectric signals in terms of perceived brightness and output voltage, the signals are stored as an image and then subjected to a process comprising the steps of:
photographing the images of LED lighting under different conditions;
loading the images of LED lighting for the RGB components extraction;
converting the images into a matrix containing the RGB and brightness values of each pixel;
processing the matrix to find the most frequent color from all pixels over the image selected;
counting the occurrence of individual RGB components and sorting them in descending order,
choosing six color matrices that are the most frequently observed in the image by sorting them in the orders of RGB, RBG, GRB, GBR, BGR, and BRG; and
selecting the brightest color components as a representative color of the image.

17. The smart skin of claim 16 further including the step of once the user loads the snapshot image to be analyzed, resizing and cropping it to remove the background.

18. The smart skin of claim 16 wherein brightness was estimated by the equation B=√(0.299 R\hat{ }2+0.587 G\hat{ }2+0.114 B\hat{ }2) where R, G, B indicate the values of RGB color components on a 0 to 255 scale.
